(19) United States
(12) Patent Application Publication
(10) Pub. No.: US 2017/0307433 A1
(43) Pub. Date: Oct. 26, 2017

(54) CONTAINER WITH INTEGRATED SCALE

(71) Applicant: Jose Espinosa, Sunrise, FL (US)

(72) Inventor: Jose Espinosa, Sunrise, FL (US)

(21) Appl. No.: 15/498,386

(22) Filed: Apr. 26, 2017

Related U.S. Application Data
(60) Provisional application No. 62/327,980, filed on Apr. 26, 2016.

(51) Int. Cl. G01G 19/52; B65D 90/48; B65D 88/12; B65D 90/00; G01G 23/37; G01G 23/16

(52) U.S. Cl. CPC G01G 19/52; G01G 23/37; G01G 23/163; B65D 88/121; B65D 90/008; B65D 90/48

(57) ABSTRACT

A cargo container having a plurality of weighing sensors disposed under a plurality of floor panels for accurately weighing the contents within the cargo container and displaying an accurate weight of the contents of the cargo container for shipping purposes.

### CROSS-REFERENCE TO RELATED APPLICATION

This application is related to and claims benefit to U.S. Provisional Patent Application Ser. No. 62/327,980, filed Apr. 26, 2016, entitled Container with Integrated Scale, the entirety of which is incorporated herein by reference.

### FIELD OF THE INVENTION

The present invention relates to a cargo container, and more particularly to a cargo container with an integrated scale for weighing its contents.

### BACKGROUND OF THE INVENTION

Cargo containers are used for the transportation of goods. Cargo containers are most commonly, but not exclusively, used to transport cargo by sea, rail, and truck. There are a number of standard cargo container measurements to accommodate both the transportation of the cargo container by ships, trains, and trucks, but also to allow the shipper to appropriately pack their cargo container.

Cargo containers meet the International Organization of Standardization (“ISO”) standards for use in the intermodal transport of freight. The cargo containers manufactured from ISO standards are regulated to meet size, strength, and durability requirements. One of the reasons for this strict regulation is to guarantee the integrity of the cargo containers for the safety of the public and workers. Further, the regulations ensure the structural stability when lifted by heavy machinery for placement on ships, rails, and trucks.

All too common, a shipper does not have the means to properly weigh the contents of the container which results in delays, over packing of containers, increased costs of shipping, and violations of state, federal and international laws.

### SUMMARY OF THE INVENTION

The present invention advantageously provides a cargo container for weighing cargo container packages and cargo items thereof.

According to an embodiment of the present invention, a principal object is to provide a cargo container capable of obtaining the accurate gross weight of the cargo when packed and moved through a supply chain prior to loading aboard a ship for transport.

According to an embodiment of the present invention, another object is to provide a cargo container capable of verifying the gross weight of a packed container.

According to an embodiment of the present invention, another object is to allow a shipper to provide the terminal operator and vessel operator with an accurate gross weight of a packed cargo container in advance of being loaded onto a ship.

According to an embodiment of the present invention, another object is to allow a shipper to provide a verified gross weight via a digital display on the door of the cargo container for display at a port facility.

According to an embodiment of the present invention, another object is to provide a cargo container with an internal weighing system that allows for the applicable accuracy standards required for shipping.

According to an embodiment of the present invention, another object is to provide a processing unit capable of verification of the working operation in relation to applicable accuracy standards and requirements of the particular State in which the equipment is being used.

According to an embodiment of the present invention, another object is to provide a display that provides the tare mass of the particular container visible on the exterior of the cargo container.

According to an embodiment of the present invention, another object is to provide a display disposed about the exterior of the cargo container that provides a date that the last weighing operation has been performed.

According to an embodiment of the present invention, another object is to provide a display disposed about the exterior of the cargo container that provides the name and pertinent contact and/or identification information of the party packing the cargo container.

According to an embodiment of the present invention, another object is to provide a processing unit capable of determining and/or alerting to a user whether the weighing equipment is accurate within the requirements of the State in which the equipment is being used.

According to an embodiment of the present invention, another object is to provide a weighing system that alerts of a container packed to a gross mass above a maximum permitted gross mass for permissible shipping and/or loading onto a ship.

According to a non-limiting embodiment of the present invention, another object is to provide a cargo container that is of a permanent character and accordingly strong enough to be suitable for repeated use; is specially designed to facilitate the transport of goods, by one or more modes of transport, without intermediate reloading; designed to be secured and/or readily handled, having corner fittings for these purposes; is of a size such that the area enclosed by the four outer bottom corners is either at least 14 m̂2 (150 sq. ft.) or at least 7 m̂2 (75 sq. ft.) if it is fitted with top corner fittings.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a perspective view of a cargo container in accordance with the principles of one embodiment of the present invention.

FIG. 2 is a perspective view of a cargo container with the floor boards removed in accordance with the principles of one embodiment of the present invention;

FIG. 3 is a perspective close-up portion of a container beam having weight sensors in accordance with the principles of one embodiment of the present invention; and

FIG. 4 is a perspective view of the cargo container showing the insertion of a floor panel in accordance with the principles of one embodiment of the present invention.

### DETAILED DESCRIPTION OF THE INVENTION

The present invention advantageously provides a cargo container with a scale for determining the cargo container weight after it has been packed.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

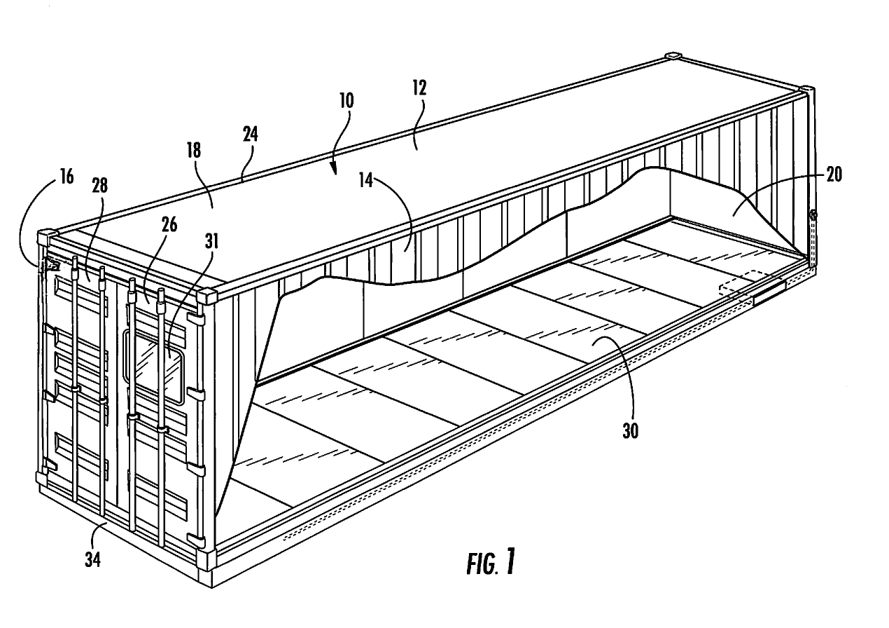

Referring now to the drawings figures in which like reference designators refer to like elements. FIG. 1 shows an exemplary cargo container constructed in accordance with the principles of the present invention and designated generally as cargo container “10.” In particular, cargo container 10 includes a container portion 12 that has opposing sidewalls 14 and 16, a top 18, a rear end 20, a door end 22. The top 18 is joined, directly or indirectly, along its outer edge 24 with the opposing sidewalls 14 and 16 and the rear end 20. The door end 22 includes opposing swing doors 26 and 28. The cargo container 10 maintains a plurality of floor panels 30.

One or more of the doors 26 and 28 include a display 31, such as an LCD display or an e-ink screen. In one embodiment, the display 31 will display a verified actual gross mass of the cargo container. In one embodiment, the display 31 will display the date of last service including date of national certification and/or calibration.

Although the cargo container 10 is shown as a forty foot (40 ft.) dry cargo container, other dimensions may be implemented without departing from the spirit and scope of the instant invention, such as a forty foot (40 ft.) refrigerated cargo container (“40 ft. reefer”), forty five (45 ft.) dry cargo container, twenty foot (20 ft.) dry cargo container, and twenty foot (20 ft.) refrigerated cargo container (“20 ft. reefer”).

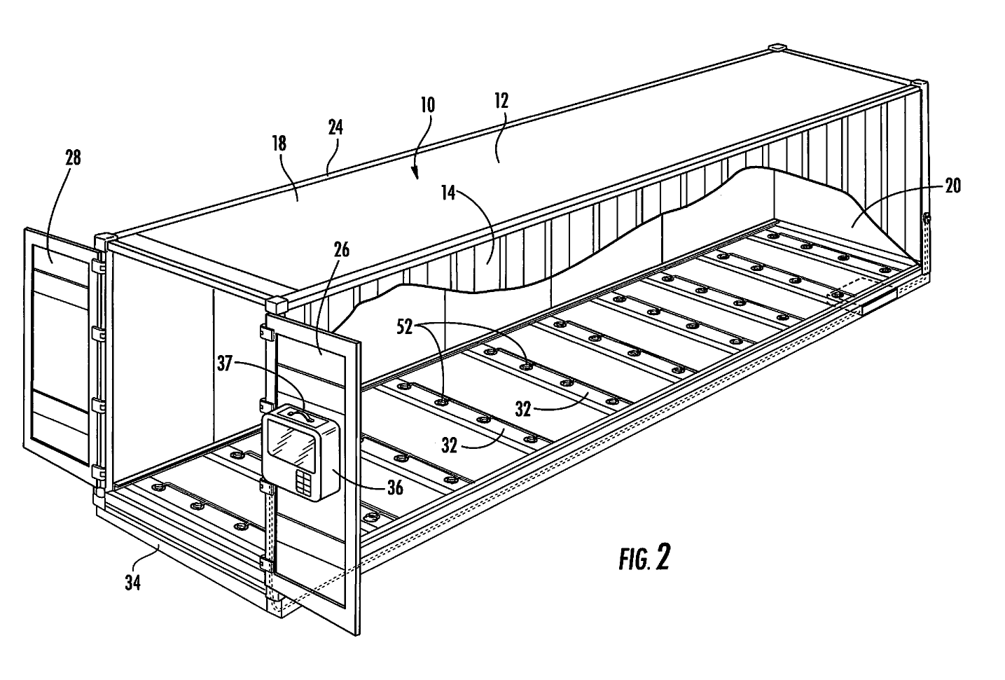

Referring now to FIG. 2, cargo container 10 is shown without the plurality of floor panels 30, the cargo container having its doors 26 and 28 swung into a particular non-limiting opened position. The cargo container further includes a plurality of floor retaining beams 32 for supporting the plurality of floor panels and/or packages and/or cargo items. The plurality of retaining beams 32 extend between a base portion 34 of the cargo container and the opposing sidewalls 14 and 16. The opposing sidewalls 14, 16 and rear end 20 are joined, either directly or indirectly to the base portion 34.

A processing unit 36 is provided with the cargo container 10. In one non-limiting embodiment, the processing unit 36 is disposed about at least on door 26 and 28, and as discussed further herein, is in communication with a plurality of weighing sensors 38 for accurately weighing the contents of the cargo container. In one non-limiting embodiment (not shown), the processing unit 36 is flush with the inside of at least a portion of the door 26. In one non-limiting embodiment (not shown), the processing unit 36 has a slim casing when disposed about at least one of door 26 and 28.

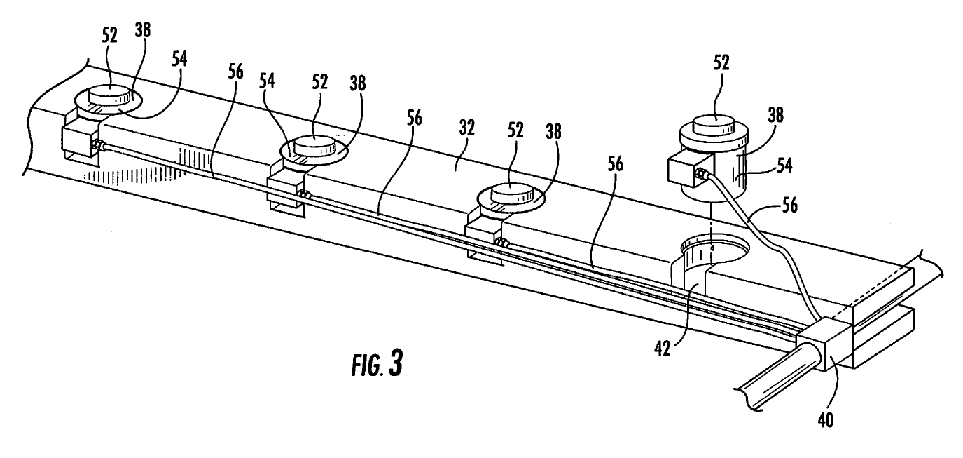

Referring now to FIG. 3, the processing unit 36, shown in FIG. 2, is connected with a plurality of weighing sensors 38 via a connection assembly 40, the connection assembly shown in FIG. 3. The weighing sensors 38 may be analog or digital or some other version of weighing sensor capable of accurately weighing. In one non-limiting embodiment, each of the plurality weighing sensors include a depressible portion 52 for depressing when receiving weight from items resting on one or more of the plurality of floor panels 30 for purposes of allowing processing of weighing. Each of the depressible portions depress into the bodies 54 of the weighing sensors 38. A plurality of cables 56 being either analog and/or digital cables are connected, either directly or indirectly between the processing unit 36 and the weighing sensors 38 for determining an accurate weight of the contents of the cargo container 10. In the instant embodiment, each of the plurality of cables 56 individually routed either directly or indirectly to a processing unit 36, the processing unit being either analog or digital. In an embodiment, each of the plurality of cables 56 may be daisy chained directly or indirectly to a processing unit 36, the processing unit being either analog or digital.

In one embodiment, the processing unit 36 includes a processor (not shown) or other computing means for calculating the weight of goods or other items on the plurality of floor panels 30. The processing unit 36 optionally includes a replaceable battery pack 37 that allows for a user to quickly swap out spent batteries packs with fresh battery packs. The processing unit 36 includes a weighing system calibration function for calibrating a weighing function. In an embodiment, the processing unit 36 may calculate weight based on analog or digital weighing sensors.

In an embodiment, the plurality retaining beams 32 each include a plurality of sensor retaining apertures 42 constructed and arranged to retain the plurality of weighing sensors 38.

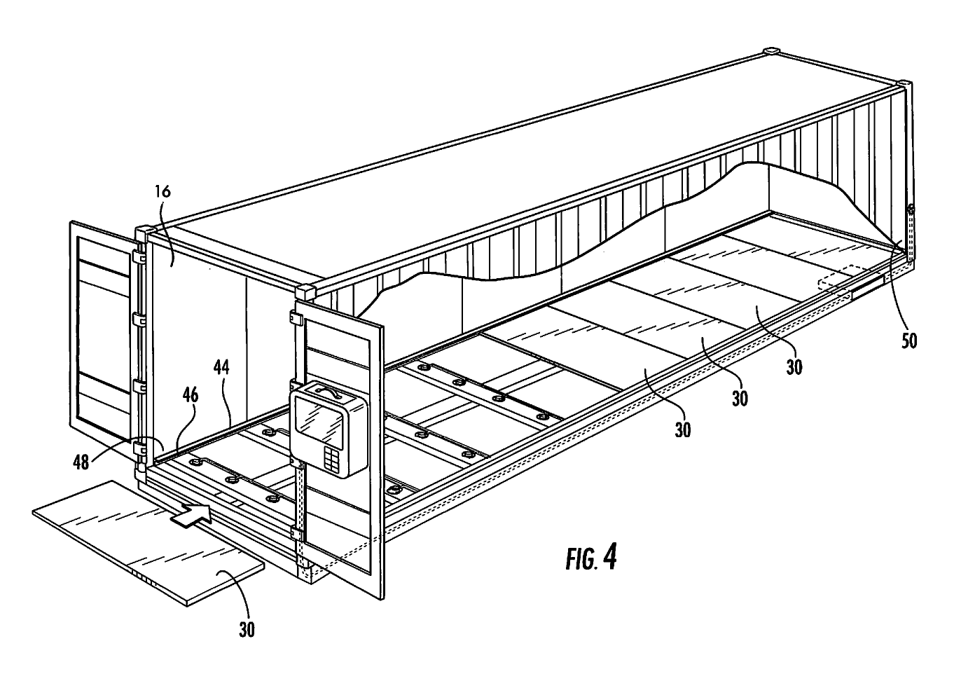

Referring now to FIG. 4, a dual retaining lip 44 is provided along the inner length of the cargo container along the bottom portion 48, 50 interior thereof of each of opposing sidewalls 14 and 16 for slidably installing and/or retaining the plurality of floor panels 30. In operation, the plurality of floor panels 30 are slid into the cargo container 10 through the doors 26 and 28, each of the dual retaining lips 44 situated along the length of the cargo container 10 on opposing sides include a portion 46 extending perpendicular in relation to the opposing sidewalls 14, 16, which in operation prevent the floor panel from lifting out of place once slid into place. In further operation, the plurality of floor panels 30 are slid to sit on top of the plurality of weighing sensors 38 for causing depression of the floor panels 30 against the weighing sensors 38 when cargo is loaded into the cargo container for weighing purposes.

In an embodiment, the processing unit 36 calculates the gross weight or the gross mass, wherein gross weight means the combined weight of the cargo container's tare weight and the weight of all packages and cargo items, including pallets, dunnage and other packing material and securing materials packed into the container, wherein tare weight means the weight of an empty container that does not contain any packages, cargo items, pallets, dunnage, or any other packing material or securing material. A packed container may include those materials such as liquids, gases, solids, packages, and cargo items including pallets, dunnage, and other packing material and securing materials, wherein packing material means any material used or for use with packages and cargo items to prevent damage, including, but not limited to, crates, packing blocks, drums, cases, boxes, barrels, and skids, but excludes from this definition any material within individual sealed packages to protect the cargo item(s) inside said sealed package. Securing material means all dunnage, lashing and other equipment used to block, brace, and secure packed cargo items in a container.

In operation, the weighing sensors 38 and/or the processing unit 36 may be powered via a battery, capacitor, or other outside power source.

Any type of display 31 may be implemented within the spirit and scope of the present invention, including those screens that continue to display without the need for maintained power, such as an e-ink display.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure. All embodiments are non-limiting in nature.

What is claimed is:

1. A cargo container comprising:
a container structure having opposing sidewalls, a top, a rear end, a door end, and a floor support structure, said top having an outer edge, said top being joined about outer edge with said opposing sidewalls and said rear end, said door end having dual opposing swing doors, said opposing sidewalls having a lower portion, said floor support structure affixed with said lower portion;
a plurality of floor panels positioned over at least a portion of said floor support structure, said floor panels having opposing ends; and
a digital display affixed to an outside of said container structure capable of displaying a weight of at least contents of said cargo container.

2. The cargo container of claim 1 further comprising at least one weighing sensor coupled with said container structure for facilitating displaying said weight about said digital display.

3. The cargo container of claim 2 further comprising a processing unit coupled between said at least one weighing sensor and said digital display.

4. The cargo container of claim 3 further comprising a connection assembly fed along an inside perimeter of said container structure, wherein said connection assembly facilitating weight sensing information of said at least one weighing sensor with said processing unit.

5. The cargo container of claim 4 wherein said connection assembly is constructed in a daisy chain configuration.

6. The cargo container of claim 4 further including a replaceable battery pack for powering at least one of said processing unit and said at least one weighing sensor.

7. The cargo container of claim 4 wherein said floor support structure includes a plurality of sensor retaining beams, said plurality of sensor retaining beams having one or more sensor retaining portions for supporting said at least one weighing sensor.

8. The cargo container of claim 7 wherein said floor panels resting on a top of a plurality of said weighing sensors.

9. The cargo container of claim 8 further comprising a floor retaining lip facilitating the lateral insertion of said floor panels about said container structure through said opposing swing doors, wherein said floor retaining lip obstructs vertical removal of said floor panels within said container structure.

10. The cargo container of claim 9 wherein said floor panels configured to receive cargo content on a surface of said floor panels for depressing at least one weighing sensor thereby causing calculation and displaying of said weight.

11. The cargo container of claim 10 wherein said processing unit configured to calculate tare weight and wherein said digital display configured to display said calculated tare weight.

12. The cargo container of claim 10 wherein said processing unit configured to calculate gross weight and wherein said digital display configured to display said calculated gross weight.

13. A cargo container comprising:
a container structure having opposing sidewalls, a top, a rear end, a door end, and a floor support structure, said top having an outer edge, said top being joined about outer edge with said opposing sidewalls and said rear end, said door end having dual opposing swing doors, said opposing sidewalls having a lower portion, said floor support structure affixed with said lower portion;
a plurality of floor panels positioned over at least a portion of said floor support structure, said floor panels having opposing ends;
a digital display affixed to an outside of said container structure capable of displaying a weight;
a processing unit coupled between said at least one weighing sensor and said digital display;
a connection assembly fed along an inside perimeter of said container structure, wherein said connection assembly facilitating weight sensing information of said at least one weighing sensor with said processing unit;
a replaceable battery pack for powering at least one of said processing unit and said at least one weighing sensor;
a floor retaining lip facilitating the lateral insertion of said floor panels about said container structure through said opposing swing doors, wherein said floor retaining lip obstructs vertical removal of said floor panels within said container structure;
said floor support structure includes a plurality of sensor retaining beams, said plurality of sensor retaining beams having one or more sensor retaining portions for supporting said at least one weighing sensor;
wherein at least one weighing sensor coupled with said container structure for facilitating displaying said weight about said digital display;
wherein said floor panels resting on a top of a plurality of said weighing sensors; and
wherein said floor panels configured to receive cargo content on a surface of said floor panels for depressing at least one weighing sensor thereby causing calculation and displaying of said weight.
